(19) United States
(12) Patent Application Publication
(10) Pub. No.: US 2017/0050583 A1
(43) Pub. Date: Feb. 23, 2017

(54) Twist Lock Diecast Fastener Assembly

(71) Applicant: Hi-Lex Controls, Inc., Rochester Hills, MI (US)

(72) Inventors: Kevin Koneval, Macomb Township, MI (US); Masayuki Matsushita, Rochester Hills, MI (US)

(73) Assignee: Hi-Lex Controls, Inc.

(21) Appl. No.: 14/830,147

(22) Filed: Aug. 19, 2015

(51) Int. Cl. B60R 13/02

(52) U.S. Cl. CPC B60R 13/02

(57) ABSTRACT

A fastening system particularly adapted for joining automotive hardware components to body components, such as a window regulator module plate to the door inner panel. The system employs a joint element featuring twist in attachment and retention. The joint element includes features which enable it to be assembled to the module plate and a partially assembled shipping condition and a final assembled position in which the components are fastened together. The system provides rapid assembly with reliable mounting security and validation.

### FIELD OF THE INVENTION

The present invention is related to a fastener assembly particularly adapted for use with automotive body hardware components.

### BACKGROUND

In the design and assembly of automotive components, it is often necessary to attach a subassembly unit to a vehicle body component. An example is the attachment of an automotive side door glass window regulator assembly which is mounted to a door inner panel. Window regulators include components which enable the side door glass to be raised and lowered, either manually or more typically through electric motor power actuation. The regulator assembly is frequently embodied in the subassembly including a molded housing which must be attached to the door inner panel sheet-metal. Various fastening approaches are known to make this connection including discrete fasteners such as threaded fasteners and deformable types such as rivets. For any automotive component intended for mass production, low-cost rapid assembly and quality assurance are essential requirements. These desires are facilitated by making the assembly process easily carried out in a production environment. Threaded fasteners such as a headed bolt threaded into a weld nut require multiple components and take time to achieve assembly, since the fastener must be rotated over numerous revolutions to achieve the final mounted condition. Threaded fasteners also pose the disadvantage that they generally need to be handled separately from the mounted subassembly which requires greater part counts, inventory, and part handling provisions. Accordingly there is a need in the art to provide improvements in such a subassembly mounting fastener systems.

### SUMMARY

A fastener system is provided in accordance with the present invention which utilizes a twist lock type fastener element which can be mounted to a sub assembly such as a window regulator for shipping, and once mated with the associated vehicle structure, can be actuated to reach a final assembled condition. The fastener system in accordance with the present invention enables rapid and secure fastening, and avoids lose part conditions which give rise to buzz, squeak, and rattle issues.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

FIG. 1 is a side view of a window regulator module plate adapted for installation to a motor vehicle side door inner panel;

FIG. 2 is an exploded view showing the twist lock diecast fastener assembly, module plate, and sheet-metal panel;

FIG. 3 is an isometric view of the joint element;

FIG. 4 shows details of the mounting socket of the module plate viewed from the sheet-metal panel side;

FIG. 5 is the side view of the joint element;

FIG. 6 is an elevational view of the mounting socket portion of the module plate showing the joint element in the rotated shipping position;

FIGS. 7 and 8 are enlarged partial views of the module plate mounting socket showing the interaction between a portion of the joint element and the socket;

FIGS. 9A through 9F show the sequence of assembly of the fastener system; and

FIG. 10 is a cross-sectional view through the fastening system in the final assembled condition.

### DETAILED DESCRIPTION OF INVENTION

The fastening system in accordance with this invention is illustrated by the figures and generally includes joint element 10, module plate 12, and sheet-metal component 14.

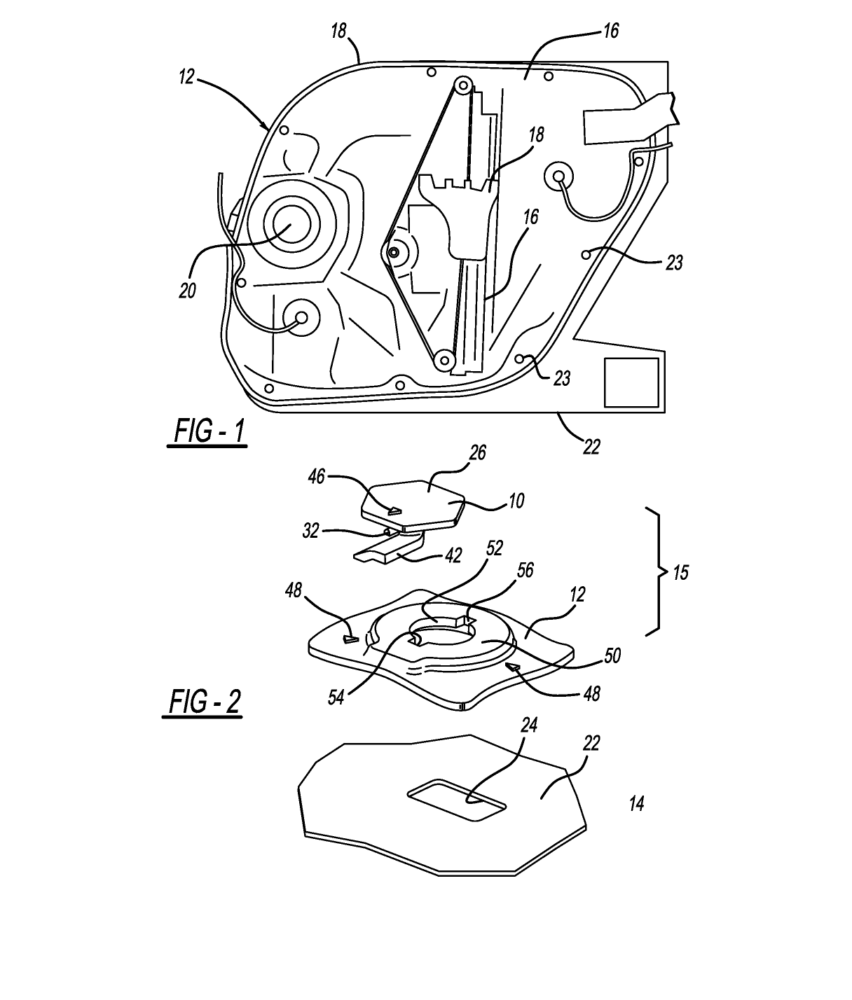

Module plate 12 is best described with reference to FIG. 1. As illustrated, module plate 12 is a molded unit which carries components of an automotive window regulator mechanism, which includes slide rail 16 having window carrier 18 slidably mounted thereon, and drive motor assembly 20. Module plate 12 as a subassembly carries all the primary elements of the window regulator unit in which window carrier 18 is attached to side door glass (not illustrated) to move the glass between closed and opened conditions. It is necessary to mount module plate 12 to door inner panel 22 during vehicle body production. As described previously, discrete fasteners are typically used to provide the connection between module plate 12 and door inner panel 22, and has been primarily in the form of threaded or deformable fasteners in accordance with the prior art. The fasteners in accordance with this invention are mounted through fastener holes located around the perimeter of module plate 12.

FIG. 2 shows the primary elements of the present system in accordance with the present invention. Module plate 12 is shown in FIG. 2 in a cutaway illustration depicting only the portion of the module plate which interact with the fastening system in accordance with this invention. Similarly, sheet-metal component 14 which features a rectangular cutout hole 24 is a portion of a larger door inner panel (or other mounting panel or structure) affixed to or part of the inner door structure. When assembled, joint element 10 fastens module plate 12 to door inner panel 22 at a number of location holes 23; nine such positions are shown in FIG. 1, although the number of discrete fasteners is a matter of design choice based on application requirements. It is further noted that the fastening system in accordance with this invention may be used to make other types of connections, not just between the components of motor vehicles but also for other machines and devices.

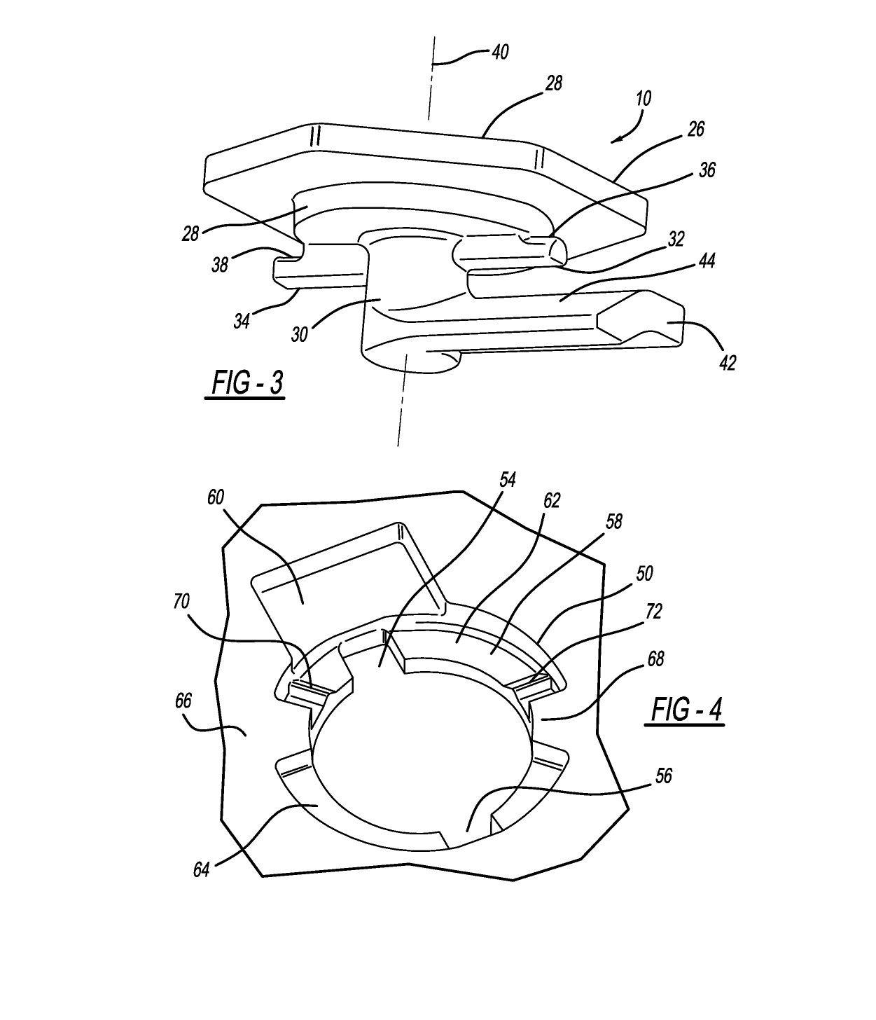

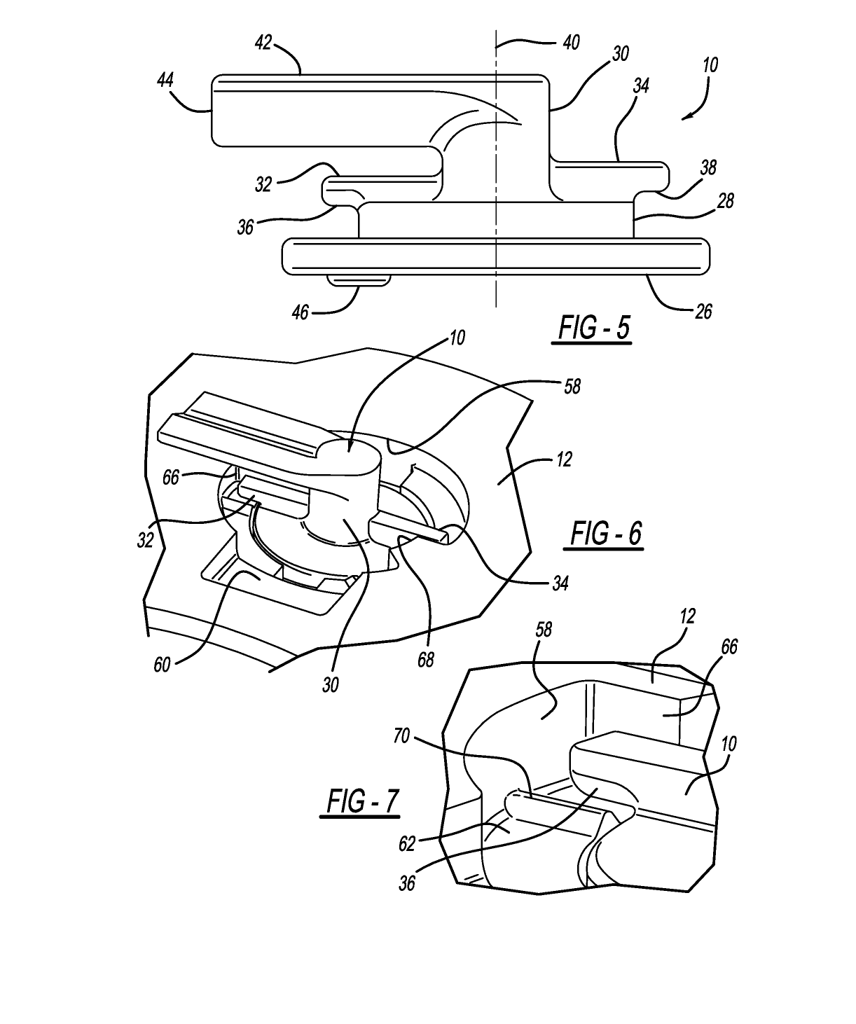

Now with particular reference to FIGS. 2, 3, 4, and 5, features of joint element 10 are shown in more detail. Joint element 10 forms a flattened head 26 which has a hexigonal shape, and is joined with cylindrical shoulder 28. Post 30 extends from the center of joint component 10. A pair of extending engagement arms 32 and 34 are provided which extend from post 30 radially past the outer edge of cylindrical shoulder 28. Engagement arms 32 and 34 form engagement surfaces 36 and 38 respectively which are positioned at different planes perpendicular to the longitudinal axis 40 of joint element 10. This displacement is especially evident with reference to FIG. 5. Engagement wing 42 extends radially from post 30 and is shaped to be inserted into cutout hole 24 and mechanically engage with sheet-metal component 14. Wing 42 further forms ramp surface 44 which provides a function which will be described later. Joint element 10 can be formed of numerous materials and in a preferred embodiment is formed of diecast light metal (e.g. zinc), but could alternatively be formed of injection molded polymeric plastic material or by other processes and materials. So that the rotated orientation of joint 10 can be determined visually, the external surface of head 26 may feature projection 46 or another witness mark. Additional projections 48 or witness marks may be provided on a surface of module plate 12 which when aligned with projection 46, indicates a desired rotated position of joint component 10.

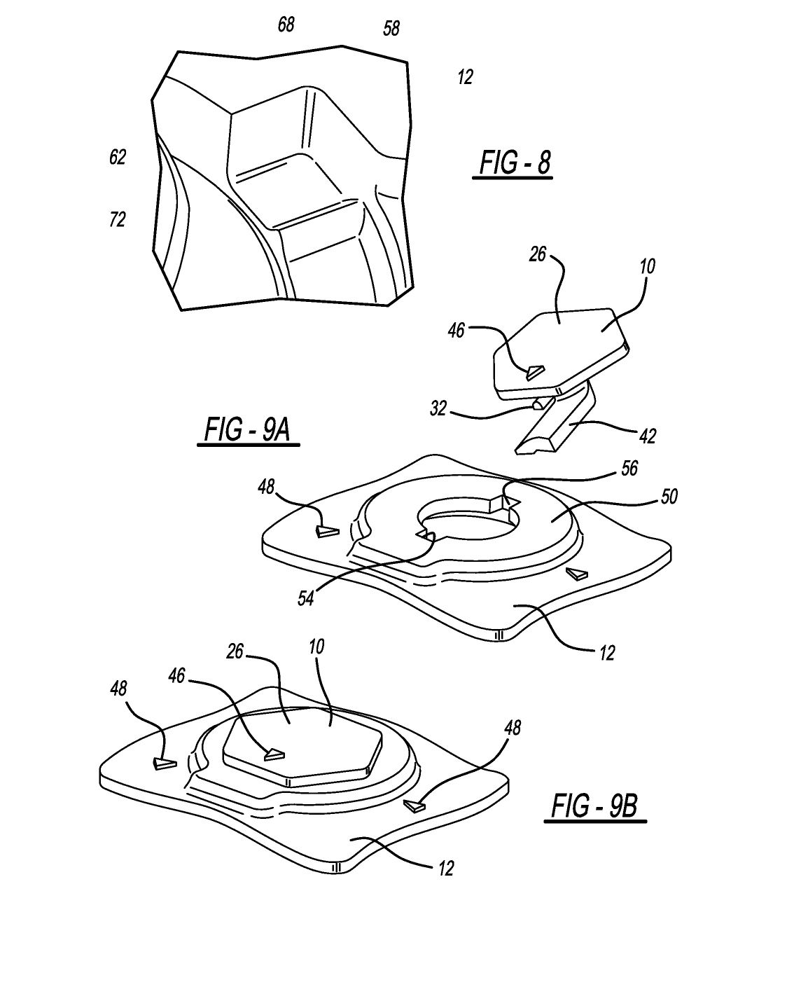

Now with particular reference to FIGS. 2 through 8, details of module plate 12 will be described. As mentioned previously the portion of module plate 12 illustrated is cut away from the remainder of a larger component. Module plate 12 forms number of mounting sockets 50, each having an identical configuration with a central keyhole 52 which has a generally round perimeter edge with a pair of diametrically opposed cutouts 54 and 56. Mounting socket 50 features a recessed pocket 58 concentric around keyhole 52 with extension pocket 60. FIG. 2 shows one side of module plate 12 illustrating that mounting socket 50 is displaced from the main surface of the mounting plate and forms a concave dished-out area on one side, and a protruding region on the other. The inner edge of mounting socket 50 adjacent to keyhole 52 forms a pair of arcuate tracks 62 and 64. Each of tracks 62 and 64 trace partial arcs around the center of keyhole 52 and each sweep an arc of less than 180°. Tracks 62 and 64 terminate at both their circumferential ends at diametrically opposed stop tabs 66 and 68. Retainer ribs 70 and 72 are provided near the arcuate and a both ends of track 62 adjacent to the stop surfaces formed by stop tabs 66 and 68. Track 64 also terminates at surfaces of stop tabs 66 and 68. Track 64 does not include retainer ribs such as ribs 70 and 72, but such ribs could be provided as an alternative embodiment.

Module plate 12 can be formed of the numerous materials. In a preferred embodiment, module plate 12 is made of a polymeric plastic by an injection molding process.

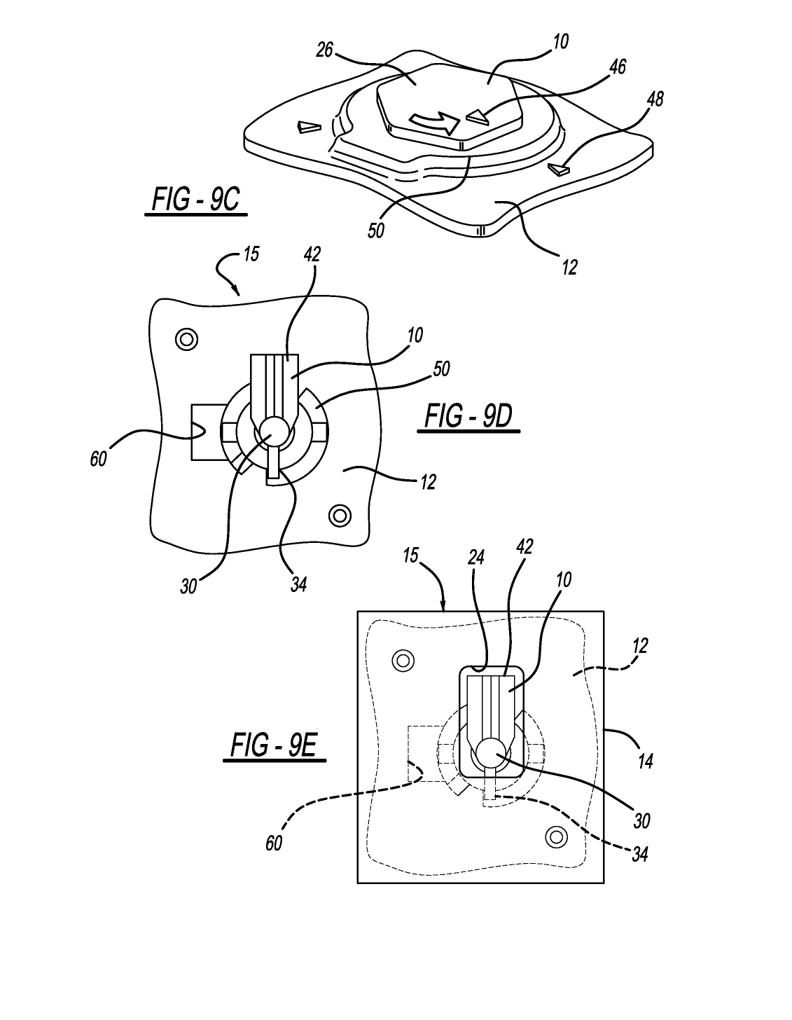

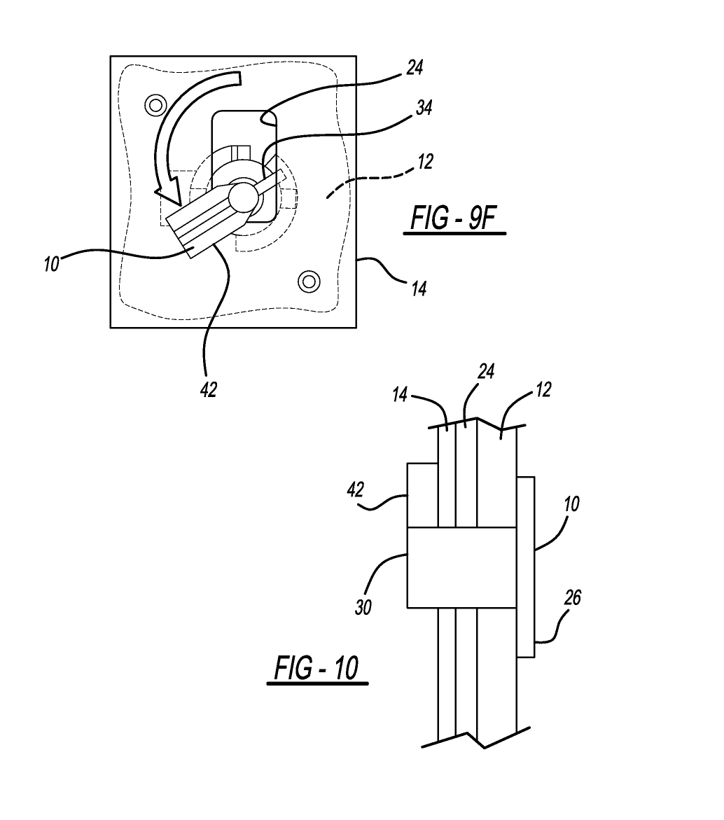

Now with specific reference to FIGS. 6 through 9A-F, the interaction between features of the joint element 10 and module plate 12 will be described in more detail. FIG. 9A illustrates the insertion of joint element 10 into keyhole 52. Extension pocket 60 is provided to provide clearance for the insertion of the joint element wing 42. Keyhole cutouts 54 and 56 are positioned to receive extension arms 32 and 34, respectively. Module plate tracks 62 and 64 are positioned at different plane levels such that the interaction between extension arms 32 and 34 with the corresponding tracks 62 and 64 occurs only when joint element 10 is properly installed (the planes of arms 32 and 34 will not interact with the improper tracks 64 and 62, respectively). After the initial assembly of joint 10 into position on module plate 12 as shown in FIG. 9B, joint element 10 is rotated partially in the counterclockwise direction when viewed in FIGS. 9B and 9C (designated by the arrow in FIG. 9C) such that extension arms 32 and 34 sweep along arcuate tracks 62 and 64, as shown in FIGS. 9D and 9E. this position corresponds to a shipping or preassembled position of joint component 10 in module plate 12. At the rotated shipping position, engagement arms 32 and 34 abut stop tabs 66 and 68, and surface 36 of engagement arm 32 encounters retainer rib 72 which serves to maintain the extension arms at one end of the arcuate tracks 62 and 64. This configuration (shipping condition) is illustrated by FIGS. 6, 7 and 9D which show in greater detail the configuration of tracks 62 and 64 at stop tabs 66 and 68. The retention feature provided by rib 72 allows joint elements 10 to be assembled into their corresponding module plate mounting sockets 50 without becoming dislodged and disassembled during component handling, shipment, and inventory. This facilitates the final assembly process.

In the preferred embodiments illustrated, each of the arcuate tracks 62 and 64 extend circumferentially from the position of cutouts 54 and 56. With this configuration, as will be described in more detail as follows, joint element 10 can be rotated in a first rotated direction (counterclockwise in FIG. 9C) for initial assembly (referred to as a shipping condition) and then in an opposite rotated direction (counterclockwise in FIG. 9F—which views the assembly from an opposite surface than shown in FIG. 9C) to the final assembled condition.

After the preassembled condition is achieved in which each of joints 10 is affixed to its associated mounting socket 50 in the shipping condition as shown by FIG. 9D, the module plate 12 assembly can be applied to sheet-metal component 14. Joint wings 42 are positioned to be received by corresponding cutout holes 24 as illustrated in FIG. 9E. In this position, joint 10 is then rotated in a direction opposite the initial assembly, causing extension arms 32 and 34 to reach the opposite arcuate ends of tracks 62 and 64, pass the intermediate position shown in FIG. 9F. In the final assembly condition, engagement arms 32 and 34 engage with stop tabs 66 and 68, and retainer lip 70 maintains the joint component in the final assembled position. Wing 42 is displaced out of registration with cut out hole 24 and in the final assembly position and the components are mechanically interlocked. Ramp surface 44 of wing 42 causes the components to be clamped together or tightened up during rotation of the joint component 10 to the final installed condition. This ramp or cam feature is best shown with reference to FIG. 10 which shows the clamped condition of the components. In a preferred embodiment, gasket 74 is provided as a discrete component or formed in place against either module plate 12 or on a surface of door inner panel 22.

As mentioned previously, joint element 10 may incorporate projection 46 which will enable a rapid visual inspection to ensure the proper assembled condition and position of head 26 with respect to an associated projection 48. Joint element head 26 can be rotationally driven by an associated hexagonal shaped driver tool or other tool which corresponds to the outer perimeter shape of head 26, or other driving tools may be provided which would engage with corresponding molded or formed features of head 26 (e.g. flat or Phillips screwdriver, Torx, or Allen type driver tools).

The hook engagement provision provided by wing 42 provides a large interface surface area between the module plate 12 and joint element 10 which can prevent high point stress acting on sheet-metal component 14. For embodiments of the present invention in which joint element 10 is formed of diecast material it may be important to properly oriented device since wing 42 represents a mass, which if not properly oriented, could cause undesired rotational forces due to gravity or inertia during transportation of the subassembly. In such conditions it may be desirable to orient wing 42 in a vertically up or downward position. Similarly in a final assembly condition it may be desirable to orient wing 42 in a position such that gravitational forces urge the joint component to be rotated toward the locked final position.

While the above description constitutes the preferred embodiment of the present invention, it will be appreciated that the invention is susceptible to modification, variation and change without departing from the proper scope and fair meaning of the accompanying claims.

1. A fastening system for mounting the component to a structure, featuring an aperture, comprising:
a joint element forming a cylindrical shoulder with a head on a first axial end of the shoulder and an extension wing protruding radially from a central post portion of the joint element adjacent an opposite second axial end, the joint element, adjacent an opposite second axial end further including a pair of extension arms extending radially from the post and extending beyond the surface of the cylindrical shoulder,
the component forming a mounting socket for receiving the joint element, the mounting socket forming a keyhole for receiving the joint element with a cutout for each of the extension arms, and forming a pocket, the mounting socket forming a pair of partially arcuate tracks extending around the perimeter of the inner edge of the keyhole and terminating at stop tabs, and
the interaction between the joint element and the mounting socket enabling the joint element to be inserted into the component mounting socket and rotated in a first rotational direction to retain the joint element fastened within the mounting socket in a first condition and further enabling attachment of the component to the structure through rotation of the joint element in a second opposite rotational direction causing the extension wing to engage with the structural component in a second condition.

2. The fastening system in accordance with claim 1 further comprising the engagement arms positioned at different planes perpendicular to the longitudinal axis of the joint component and the arcuate tracks positioned at different planes such that the joint element may only be assembled into the mounting socket in a single indexed position.

3. The fastening system in accordance with claim 1 further comprising wherein at least one of the tracks includes a first retainer lip which interacts with at least one engagement arm to maintain the joint element in the first condition.

4. The fastening system in accordance with claim 1 further comprising wherein at least one of the tracks includes a second retainer lip which interacts with at least one engagement arm to maintain the joint element in the second condition.

5. The fastening system in accordance with claim 1 further comprising the wing forming a ramp surface which wedges against the structure to clamp the component against the structure when the joint element is rotated to the second condition.

6. The fastening system in accordance with claim 1 further comprising the joint element formed of diecast metal.

7. The fastening system in accordance with claim 1 further comprising the component formed of a molded polymeric plastic material.

8. The fastening system in accordance with claim 1 further comprising a gasket formed of a compressible material positioned between the component and the structure.

9. The fastening system in accordance with claim 1 further comprising the joint element head defining a drive shape enabling the joint element to be rotated using the tool.

10. The fastening system in accordance with claim 1 further comprising wherein the head forms a visual witness feature enabling the rotated position of the joint element relative to the component to being visually inspected.

11. The fastening system in accordance with claim 1 wherein the structure is in the form of an automotive door inner panel, and the component is a window regulator module plate.
